(19) United States
(12) Patent Application Publication
(10) Pub. No.: US 2015/0093724 A1
(43) Pub. Date: Apr. 2, 2015

(54) SYSTEM FOR THE IDENTIFICATION AND SELECTION OF THREAD COLOR FOR USE IN THE MACHINE EMBROIDERY OF FABRICS

(71) Applicant: Ann L. SCHMIDT, Houston, TX (US)

(72) Inventor: Ann L. SCHMIDT, Houston, TX (US)

(21) Appl. No.: 14/496,638

(22) Filed: Sep. 25, 2014

Related U.S. Application Data
(60) Provisional application No. 61/884,648, filed on Sep. 30, 2013.

(51) Int. Cl. G09B 19/00; G09B 19/20; D05C 17/00

(52) U.S. Cl. CPC G09B 19/0023; D05C 17/00; G09B 19/20
USPC 434/95; 112/439

(57) ABSTRACT

A system for the determination of thread color includes a fabric having a surface thereon, a digitized embroidery chart stitched on the fabric so as to form a fabric chart, and a recording chart that corresponds to the fabric chart. The fabric has a solid color or multi-color pattern thereon. The fabric chart includes multiple colors in a row or in a column and multiple stitch types in another row or in another column. The fabric chart includes indicia formed thereon associated with the rows or with the columns. The recording chart also includes a plurality of rows and a plurality of columns, along with an alphanumeric character corresponding to the indicia on the fabric chart.

### RELATED U.S. APPLICATIONS

The present application claims priority from U.S. Provisional Patent Application Ser. No. 61/884,648, filed on Sep. 30, 2013, and entitled “System for the Identification and Selection of Thread Color for Use in the Machine Embroidery of Fabrics”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the process of machine embroidery. More particularly, the present invention relates to the selection of thread colors for use in such machine embroidery. Additionally, the present invention relates to systems that are utilized so as to compare thread colors against a fabric or fabrics.

2. Description of Related Art Including Information Disclosed under 37 CFR 1.97 and 37 CFR 1.98.

Machine embroidery is the process of employing colored threads that are stitched onto fabric via a computer-digitized design to create an image. The image may be a simple design element, such as a leaf or a loose fill background, or a picture composed of several design elements to create complex images, such as a holiday scene, a birdbath in a garden or a landscape. Machine-embroidered images can be used on fabrics, including shirts, blouses, jeans and children's wear, decorative pillows, linens, bath towels, purses and quilts. These choices involve unlimited fabric colors which must be taken into consideration when selecting thread colors.

Embroidery involves the application of stitches arranged in patterns. The pattern may include a run or walk stitch in various plies, a motif stitch, satin stitch, loose fill stitch or solid fill stitch. In particular, the fill stitch patterns involve directional stitching which, with the play of light on the thread color, may appear to alter its hue. Typically, users of machine embroidery will choose from an array of manufacturers' threads, primarily in polyester and rayon. These threads are developed specifically to handle the demand of the ability of embroidering machines. In particular, the embroidering machines can carry up to 1000 or more stitches per minute. Light reflection from the stitch patterns can enhance the stitch effects.

Machine embroidery will typically utilize an embroidery hoop in order to position the fabric and keep it free of wrinkles Typically, a stabilizer medium is layered beneath the fabric or “floated” under the hoop to secure the stitches and avoid puckering. In the event of quilting, batting may also be placed under the fabric to add loft. Most contemporary machine embroidery is stitched using a computerized embroidery machine with digitized software patterns downloaded to the machine. In machine embroidery, different types of stitch patterns create “fills” and add texture and design to the finished work. The creation of texture and the direction of stitching alters the hue of the thread color.

Modern embroidery is commonly created on sewing equipment that pairs a sewing mechanism with a means for synchronously moving a textile beneath that sewing mechanism. More specifically, a textile is moved in forward, back, left, or right directions while the sewing mechanism embeds stitches of thread within that textile having locations dictated by the aforementioned movements. Thus, as the process progresses, a pattern of stitching emerges that is designed to represent a particular image or graphic. Embroidered designs are quite common on a wide variety of garments or products such as baseball caps, sweaters, or golf shirts. Furthermore, these designs are often produced such that they contain a variety of different thread colors to best represent the aesthetics of the graphic being depicted. For example, an embroidery design depicting the image of a basketball might use orange thread stitching to depict the round circular area of the ball and then use smaller black thread stitching to depict the outline and other black lines that are present within the ball's image. Thus, two different thread colors, orange and black, are utilized to create embroidery representing the basketball design. A third color can be used to give the ball a stippled texture. Additional subtle colors can provide shading so as to create a perceptual three-dimensional image. As these designs become more complex or sophisticated, these designs may require an even greater number of different thread colors. In fact, many embroidery designs may require more than a dozen unique colors of thread, where each different part of the design is embroidered using a different thread color.

In view of the large number of colors of embroidery threads that are available to the user, it becomes quite difficult to accurately determine the proper thread color for use on a particular fabric. Typically, a person will look at a color chart of threads and compare the color chart with the intended fabric. In other circumstances, the embroidery thread can be placed in close proximity to the fabric so that the user will have idea of the relationship between the color of the embroidery thread and the fabric. Whenever a large number of threads of similar colors or even varying colors are utilized, it becomes quite difficult for the user to accurately remember which thread is intended for which location on the fabric and to determine which threads are available for proper use. There are literally thousands of thread choices available. For example there may be thirty colors of red to compare. Additionally, the user will have a very difficult time in determining how the appearance of one particular type of stitching, such as solid fill stitching, loose fill, or satin stitching, will appear with such a color of thread when actually placed on the fabric. There are times when the user uses embroidery threads of wrong colors. After this occurs, the user must take time to remove the improper threads from the fabric without stretching, piercing or otherwise damaging the fabric or disturbing nearby threads. Often, the use of the incorrect embroidery threads can also result in a shortage of the embroidery threads. As such, a need has developed whereby the user is able to make a proper determination of the proper color on the fabric.

The creators of machine embroidery designs typically include a tutorial in pdf format that includes a thread color listing for each individual design. The thread color listing includes the manufacturer's name and thread color number used for each stitch segment of the particular design. If a user does not possess the specific manufacturer color numbers called for, the user may consult a conversion chart to discern if another manufacturer's comparable thread is available. Even though the user may possess all thread colors that are called for, it is not known how the thread colors will appear on user's fabric selection. If the user does not possess all thread colors called for, the user may consult various manufacturers' thread charts and attempt to find an appropriate thread color, as well as consult the user's personal stock of threads. Even with these methods, the user is still limited to holding a thread color against the fabric or repeatedly stitching out the full design using thread colors to determine an appropriate color blend. This involves much time and material since continuous rehoopings are required.

In the past, various patents have been issued relating to the selection of embroidery threads. For example, U.S. Pat. No. 2,016,181, issued on Oct. 1, 1935 to P. C. Sharp, discloses an embroidery kit. In this embroidery kit, a flexible thread holder has slits formed at each end thereof receive the free ends of the thread wound therearound. A removable keeper is adapted to be placed over each side of the holder. As such, the threads are available for a side-to-side comparison by the user.

U.S. Pat. No. 4,288,010, issued on Sep. 8, 1981 to J. W. Holladay, provides an embroidery thread organizer having a plurality of nestable cylindrical tubes. Each of the tubes has a number of spaced outwardly projecting annular divider members or ribs which define segregated spool portions which are adapted to accept and retain, without entanglement, respective windings of thread or yarns for later use on a selective basis. The nested tubes are preferably made of clear plastic to enable the user to see the color of the threads available and a tubular plastic case is also included to house the nested cylinders when not in use so as to protect the thread windings from dust and dirt.

U.S. Pat. No. 6,283,297, issued on Sep. 4, 2001 to M. E. Mosley, provides a method and apparatus for organizing threads for cross-stitching. The system includes a plurality of sheets having a predetermined thickness and a specific absorption characteristic so as to create a plurality of I-shaped elements as perforated or removable thread retainers. Each retainer is manufactured with indicia to indicate a particular color scheme. This indicia can be produced in a number of different languages for use by a broad spectrum of cross-stitching enthusiasts. The system includes the steps of arranging threads according to at least one predetermined color scheme for cross-stitching. A thread is selected from a variety of threads and wound around the I-shaped element. The I-shaped element is inserted within a multi-level compartment for subsequent use. A color comparison chart is used to compare thread colors.

U.S. Pat. No. 8,170,708, issued on May 1, 2012 to Goldman et al., provides a system, method and apparatus for embroidery thread management. In the method, a first set of thread colors is determined to be used in an embroidery design. A second set of thread colors is assigned to a first embroidery machine. A third set of thread colors is assigned to a second embroidery machine. A difference of the number of thread colors in the first set of thread colors that are not in the second set of thread colors is determined. Another difference of the number of thread colors in the first set of thread colors that are not in the third set of thread colors is determined. The embroidery design is assigned to a queue for the first embroidery machine when the first difference is smaller than the second difference.

U.S. Pat. No. 8,292,066, issued on Oct. 23, 2012 to M. T. Lai, provides an embroidery thread organizing card that has a thread organizing structure having a front panel and a back panel. A barcode is provided on a front side of the front panel near one corner thereof for material management. Instruction information is provided on a rear side of the back panel showing things to be noted during embroidering. A plurality of information zones are provided on the front side of the front panel. A plurality of embroidery thread groups has a number and a location corresponding to that of the information zones and are clamped at an end of the thread organizing structure. Each of the information zones shows a thread color sample and information related to the use of the corresponding embroidery thread group.

It is an object of the present invention to provide a system for the selection of a particular thread color which allows the user to accurately determine the appearance of the particular thread color with a particular fabric or fabrics.

It is an object of the present invention to provide a system for determining thread color which facilitates the ability to see tone-on-tone colors.

It is another object of the present invention to provide a system for selection of thread color which allows the user to easily identify the thread manufacturer and thread color number after a selection of the proper color is made.

It is still another object of the present invention to provide a system for selection of thread color which allows the user to show the actual stitching type with such colors.

It is still a further object of the present invention to provide a system for selection of thread color which is easy to use and relatively inexpensive.

These and other objects and advantages of the present invention will become apparent from a reading of the attached specification and appended claims.

### BRIEF SUMMARY OF THE INVENTION

The system of determination of thread color in accordance with the present invention utilizes a fabric having a surface thereon, a digitized embroidery chart that is stitched onto the fabric to create a fabric chart, a paper recording chart that corresponds to the fabric chart. In the present invention, the fabric will have a surface thereon that faces the user. The fabric, in the preferred embodiment of the present invention, will have a multi-color pattern thereon. However, within the concept of the present invention, fabrics with either a single color thereon, or no particular color, as well as a single fabric in a hoop (or multiple hoops of various sizes), or multiple fabrics hooped together or in a single hoop can be utilized in association with the present invention.

The embroidery chart is stitched onto the fabric. The resulting fabric chart will have multiple colors in a row or column and multiple stitch types in a row or column. A single stitch pattern or a combination of stitch patterns may be used that have a single or have multiple plies. In the preferred embodiment of the present invention, the same color is presented in a row and has different stitch types within such a row. Different colors will appear along a particular column. Each color is associated with different stitch types. These stitch types can include loose fill, solid fill, satin stitch, or various other available stitching. Also, the stitch types can show various types of stitches and stitching directions. An indicia is associated which each row or column. The indicia will correspond to the thread color and with a manufacturer of such color. This indicia can also correspond to a color number, a quality or a length of the thread. The quality can include the type of the material from which the thread is manufactured. In the preferred embodiment of the present invention, the indicia will be a number. Each row will be associated with a different thread color number.

The recording chart is made up of column of rows. Each row has an alphanumeric character corresponding to a number on the fabric chart. As such, each row will identify the thread manufacturer and the color number associated with the number that has been stitched onto the fabric. The columns will indicate the actual indicia that is on the fabric chart, the thread manufacturers and the color numbers. A notes section can also be provided on the recording chart.

In the present invention, an embroidery hoop is utilized. A piece of muslin is hooped. Batting may be placed on top of the muslin if the comparison is for quilting and the user prefers this. A stabilizer medium is floated under the hoop. The specific fabric or fabrics are then stitched into place. This secures the fabric(s) and batting to the muslin. The chart is stitched through these various layers within the hoop.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a plan view showing the application of a graphic of identifying thread color in accordance with the preferred embodiment of the present invention.

FIG. 2 shows the system of identifying colors in accordance with the present invention showing the application of colors onto two different types of patterns of fabrics.

FIG. 3 is an illustration of a recording chart for identifying the particular thread colors that have been placed on the fabrics.

### DETAILED DESCRIPTION OF THE INVENTION

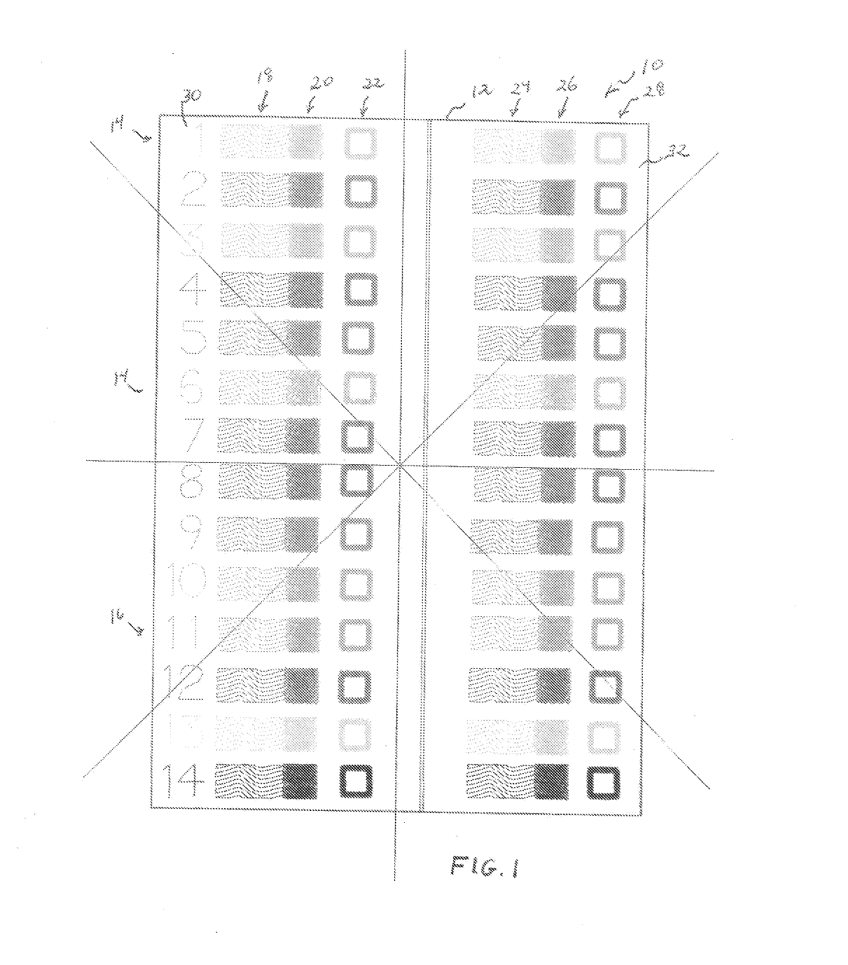

Referring to FIG. 1, there is shown the graphic 10 for the selection of a thread color in accordance with the teachings of the present invention. In particular, the graphic 10 includes a fabric chart 12 having a plurality of rows 14 and a plurality of columns. The plurality of columns includes column 18, column 20, column 22, column 24, column 26 and column 28. In particular, the columns 18, 20 and 22 are representative of colors and stitch types that are to be stitched onto a first section 30. The columns 24, 26 and 28 are stitched onto a second section 32. The sections 30 and 32 are illustrated with a white background. It is important to note that, within the concept of the present invention, the sections 30 and 32 can be of different colors and can have multiple patterns of multiple colors thereon. As such, a particular arrangement of colors is presented of different stitching types so as to allow the user to determine the proper color in association with a particular fabric.

In FIG. 1, it can be seen that each of the rows 14 is identified with a different number. In FIG. 1, the numbers range from numeral “1” to numeral “14”. The row identified with numeral “1” shows a light green color. The first column 18 illustrates a loose fill stitching associated with this light green color. The column 20 shows a solid fill stitching with this light green color. Column 22 shows a satin stitch pattern with this light green color. A similar arrangement of the same color represented by numeral “1” will appear in association with the second fabric section 32. In particular, column 24 illustrates a loose fill, column 26 shows a solid fill, and column 28 shows a satin stitch. As such, the first row 14 corresponding to the numeral “1” will show a variety of stitching patterns of the same color. The row 14 identified with the numeral “2” shows another color in which the same stitching pattern will appear in columns 18, 20 and 22. Each can be seen that each of the rows 14 identified with the numerals “1” through “14” has a different color presented thereon. As such, the user is able to compare a wide variety of particular thread colors with the fabric directly affixed thereto.

Through the system of the present invention, the user is able to a make clear determination as to the desired color to be used on the particular fabric section. Additionally, the user is able to make this determination of color with reference to the particular stitching type. In the past, a color may appear appropriate when a single thread is compared with the fabric. However, the appearance would not be proper if one used that color with a satin stitch. As such, the user is able to make a qualitative determination of color type and stitching based upon the actual fabric to be used in the final embroidery design.

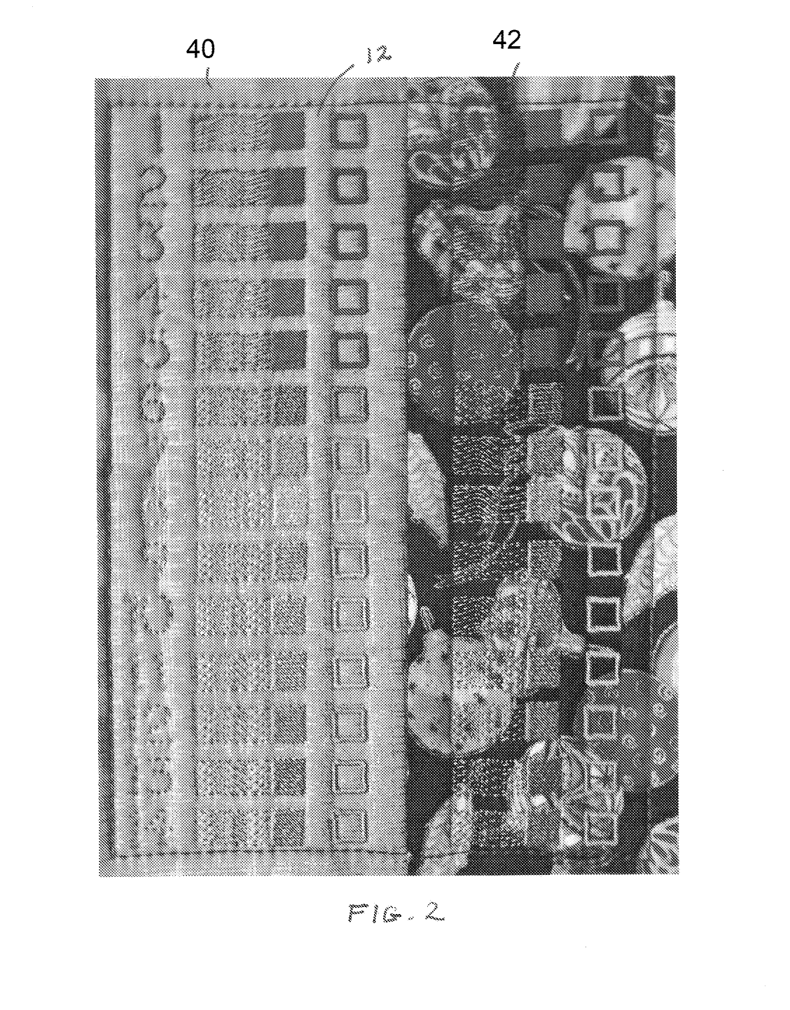

FIG. 2 shows the application of the system to a pair of fabrics 40 and 42. As can be seen, the color chart 12 is stitched directly onto the first fabric section 40 and onto the second fabric section 42. Each of the referenced numerals “1” through “14” is also stitched onto the first fabric section 40. The first fabric section 40 is of a plaid design. As such, the various colors can be presented in comparison with the first fabric section 40 so that proper decisions can be made. The second fabric section 42 is a multi-color, multi-design piece of fabric. Once again, the present invention is able to facilitate the comparison of the thread colors with respect to this particular multi-color multi-pattern design.

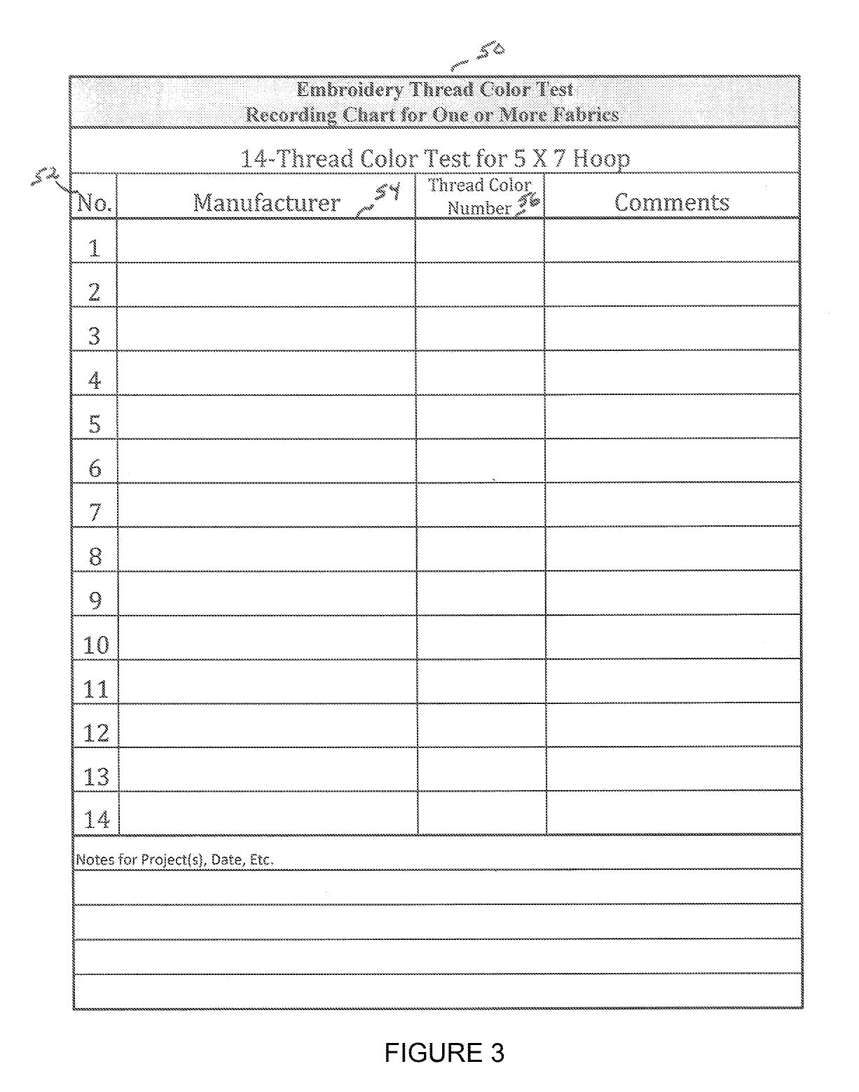

FIG. 3 shows a recording chart 50 that is utilized in association with the fabric chart 12 of FIGS. 1 and 2. In this recording chart 50, the various alphanumeric characters appear in a column 52. The thread manufacturer will appear in a column 54. The color alphanumeric characters will appear in a column 56. As such, with reference to the light green color identified with the reference numeral “1” in FIG. 1, the thread manufacturer of such a color of thread is identified in column 54 and this manufacturer's color alphanumeric character is placed in column 56. As such, for the color reference numbers “1” through “14”, the various manufacturers and color alphanumeric characters can be identified. As a result, when a selection is made based upon the chart 12 as used in comparison with the particular fabric section, the user can reference the stitched alphanumeric character on the fabric with the number on the recording chart so that a proper ordering and selection of the thread can occur.

The use of a representative stitch pattern that requires little fabric, such as in the present invention, will allow the user to place numerous thread colors on a specific fabric selection. As such, the user is able to compare the colors for a machine embroidery design against the fabric which has its own single-color or multi-color pattern. Additionally, the use of a representative stitch pattern will allow users making quilts to hoop several fabrics at once and place a single thread color in a row of the fabrics to compare the look of the thread colors against each fabric. The user can then proceed down each row with a different thread color. This allows the user to select those thread colors that look the best. The user is provided with a system (i.e. index) to record the manufacturer name and thread number for reference. The system of the present invention is also useful for those users that utilize digitized original designs and require test medium for color selection.

In the present invention, an embroidery hoop is utilized. A piece of muslin is hooped. Batting may be placed on top of the muslin if the comparison is for quilting and the user prefers this. A stabilizer medium is floated under the hoop. The specific fabric or fabrics are then stitched into place, which secures the fabric(s) and batting to the muslin. The chart is stitched through these various layers within the hoop. As such, a proper display of the appearance of the colors and the stitching types is available for the user so as to provide an accurate representation of what the color will look like once it is ultimately applied as embroidery to the fabric.

The foregoing disclosure and description of the invention is illustrative and explanatory thereof. Various changes in the details of the illustrate construction may be made within the scope of the present invention without departing from the true spirit of the invention.

I claim:

1. A system for determination of thread color comprising:
a fabric having a surface thereon;
a digitized embroidery chart stitched onto said fabric so as to form a fabric chart; and
a recording chart that corresponds to the fabric chart.

2. The system of claim 1, said surface of said fabric positioned so as to face a user.

3. The system of claim 1, said fabric having a solid color or multi-color pattern thereon.

4. The system of claim 1, said fabric chart having multiple colors in a row or in a column and multiple stitch types in another row or in another column.

5. The system of claim 4, one of said multiple colors being in a row, said multiple stitch types being said row.

6. The system of claim 4, different colors of said multiple colors being presented along said column.

7. The system of claim 4, the multiple stitch types being loose fill, solid fill, and satin stitch.

8. The system of claim 4, said fabric chart having indicia formed thereon, said indicia associated with the rows or with the columns.

9. The system of claim 8, the indicia corresponding to a thread color.

10. The system of claim 8, the indicia corresponding to a thread manufacturer.

11. The system of claim 8, the indicia corresponding to a length of the thread or a quality of the thread or a material of the thread.

12. The system of claim 8, said recording chart having a plurality of columns and a plurality of rows.

13. The system of claim 12, each of said plurality of rows having an alphanumeric character associated therewith, said alphanumeric character corresponding with said indicia of said fabric chart.

14. The system of claim 13, each of said plurality of rows of said recording chart having a thread manufacturer identification thereon.

15. The system of claim 14, each of said plurality of rows having a notes section thereon.

16. The system of claim 1, further comprising:
an embroidery hoop;
a piece of muslin affixed to said embroidery hoop, said fabric affixed to said piece of muslin.

17. The system of claim 16, further comprising:
a piece of batting positioned on top of said piece of muslin.

18. The system of claim 16, further comprising:
a stabilizer medium floated under said embroidery hoop.

19. The system of claim 16, said embroidery chart stitched through said fabric and through said piece of muslin.

20. A process for determining a thread color, the process comprising:
stitching a digitized embroidery chart on a fabric so as to form a fabric chart, said fabric chart having multiple colors in a row or in a column and multiple stitch types in another row or in another column, said fabric chart having indicia formed thereon; and
creating a recording chart having an alphanumeric character corresponding to said indicia of said fabric chart, said alphanumeric character being indicative of a manufacturer or a quality of the thread.
